(19) United States
(12) Patent Application Publication
(10) Pub. No.: US 2010/0074269 A1
(43) Pub. Date: Mar. 25, 2010

(54) METHOD AND DEVICE FOR RESERVING RESOURCES

(76) Inventor: Yangbo LIN, Shenzhen (CN)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/627,365

(22) Filed: Nov. 30, 2009

Related U.S. Application Data
(63) Continuation of application No. PCT/CN2008/071112, filed on May 28, 2008.

(30) Foreign Application Priority Data
Jun. 2, 2007 (CN) 2007101117313

(51) Int. Cl. H04L 12/56; H04B 7/212

(52) U.S. Cl. 370/401; 370/443

(57) ABSTRACT

The present disclosure relates to the communication field, and discloses a method and device for reserving resources to improve the efficiency in reserving the same type of resources. According to the disclosure, a bearer control device sends a message that instructs to reserve resources to a bearer device, wherein the message carries the description and quantity of the resources to be reserved in a specified context. The bearer device reserves the resources in the specified context according to the description and quantity of the resources in the message. After the bearer device reserves the resources in the specified context, the bearer device may return a reply to the bearer control device, so that the bearer control device can know the resource reservation result.

### CROSS-REFERENCE TO RELATED APPLICATIONS

This application is a continuation of International Application No. PCT/CN2008/071112, filed on May 28, 2008, which claims priority to Chinese Patent Application No. 200710111731.3, filed on Jun. 2, 2007. both of which are hereby incorporated by reference in their entireties.

### TECHNICAL FIELD

The present disclosure relates to the communication field, and in particular, to a resource reservation technology in an architecture where services are separated from bearers.

### BACKGROUND

A Media Gateway Controller (MGC) and a Media Gateway (MG) are two key components in a packet-switched network where services are separated from bearers. The MGC is responsible for service control, and the MG is responsible for media bearing. Thus, the service control plane is separated from the media bearer plane, which achieves the full sharing of network resources, simplifies the equipment upgrade and service extension, and reduces development and maintenance costs.

The media gateway control protocol is a primary protocol for communications between the MGC and the MG Currently, the H.248/Gateway Control Protocol (H.248/MeGaCo) and the Media Gateway Control Protocol (MGCP) are widely used, as shown in FIG. 1.

The H.248/MeGaCo protocol derives from MGCP. Taking the H.248 protocol as an example, the MG performs service bearing through the resources on the MG Such resources are represented by terminations abstractly. The associations between terminations are abstractly represented by contexts. A context may include multiple terminations. Thus, a topology is used to describe the relationship between the terminations. Terminations that are not associated with other terminations are included in a null context.

Based on the above abstract connection model, interactions between the services and the bearers are actually operations on the terminations and the contexts. Such operations are performed through command requests and replies between the MGC and the MG Command types include: Add, Modify, Subtract, Move, AuditValue, AuditCapabilities, Notify, and ServiceChange. Command parameters, also known as descriptors, are categorized into property, signal, event, and statistic. For better description, parameters with service relevancy are aggregated into a package logically.

Currently, when the MGC instructs the MG to add a termination to a context to create a media stream, media descriptors are used to describe the features of the termination. The media descriptors include a TerminationState descriptor and a Stream descriptor. The TerminationState descriptor describes termination features that are irrelevant to the stream, including parameters such as ServiceState and EventBufferControl. The Stream descriptor describes termination features related to the stream, including LocalControl, Local and Remote descriptors. The LocalControl descriptor includes parameters such as Mode, ReserveGroup, and ReserveValue. The Mode parameter describes whether a termination can receive or send media streams outside the context. The Local descriptor describes parameters for the local end to receive media streams (sent from the remote end). The Remote descriptor describes parameters for the remote end to receive media streams (sent from the local end). These parameters include IP address or port number, codec algorithm, and packet time, which are organized via the Session Description Protocol (SDP).

ReserveGroup and ReserveValue are two reservation related property parameters for resource reservation defined in the H.248 protocol, which are set to Boolean values for a single stream on the termination. Specifically, if the values of the reservation related property parameters are false, only one resource may be reserved; if the values of the reservation related property parameters are true, all resources may be reserved. If all resources may be reserved, the resource reservation standard is to meet the requirement for any independent resource of these resources. ReserveGroup describes a media group, which is formed by all the media of a same user. Thus, if the value of ReserveGroup is false, a resource is reserved for a selected media group only; if the value of ReserveGroup is true, a resource may be reserved for all possible media groups. ReserveValue describes a value collection, that is, a collection of feature values of a medium. Thus, if the value of ReserveValue is true, a resource is reserved for a selected collection of a single value only; if the value of ReserveValue is false, a resource is reserved for a collection of all possible values.

However, the current reservation related property parameters are available only for a single user. For example, at a conference, a maximum of five speakers and ten auditors must be supported. That is, the MGC needs to instruct the MG to create a context that represents the conference, and reserve resources for five terminations that can receive and send media streams outside the context and ten terminations that can only send media streams outside the context. If the preceding reservation related property parameters are used, the MGC needs to instruct the MG to add 15 terminations to the context before the 15 users access the conference, and set the reservation related properties for each stream (that is, each user) on the 15 terminations to reserve resources, which results in high communication and performance overheads and low efficiency in the resource reservation.

### SUMMARY

Embodiments of the present disclosure provide a method and a device for reserving resources to achieve a higher efficiency in reserving the same type of resources.

A method for reserving resources consistent with some embodiments is provided. The method may include:

receiving a message that instructs to reserve resources in a specified context, where the message carries a description and quantity of the resources to be reserved; and

reserving the resources in the specified context according to the description and quantity of the resources in the message.

A bearer control device consistent with some embodiments may include:

a generating unit, configured to generate a message that instructs a bearer device to reserve resources in a specified context, where the message carries a description and quantity of the resources to be reserved; and

a sending unit, configured to send the message generated by the generating unit to the bearer device.

A bearer device consistent with some embodiments may include:

a receiving unit, configured to receive a message that instructs to reserve resources in a specified context from a bearer control device, where the message carries a description and quantity of the resources to be reserved; and

an operating unit, configured to reserve the resources in the specified context according to the description and quantity of the resources in the message.

In some embodiments, the bearer control device sends a message that instructs the bearer device to reserve resources, wherein the message carries a description and quantity of the resources to be reserved in a specified context; the bearer device reserves the resources in the specified context according to the description and quantity of the resources in the message. Thus, in some embodiments, when multiple terminations (each corresponds to a user) may be added to a context that represents a conference, the bearer device can be instructed to reserve termination resources for each user by a message that instructs the bearer device to reserve resources and carries the description (for example, a termination can only send media streams outside the context) and quantity of the resources to be reserved in a specified context. When a same type of resources is reserved for multiple users, it is unnecessary to instruct to reserve the resources for each user in turn, thus improving the efficiency in reserving the same type of resources.

### BRIEF DESCRIPTION OF THE DRAWINGS

FIG. 1 shows a networking diagram of an MGC and two MGs in the prior art;

FIG. 2 is a flowchart of a method for reserving resources in a first embodiment;

FIG. 3 shows a structure of a bearer control device in a second embodiment; and

FIG. 4 shows a structure of a bearer device in a third embodiment.

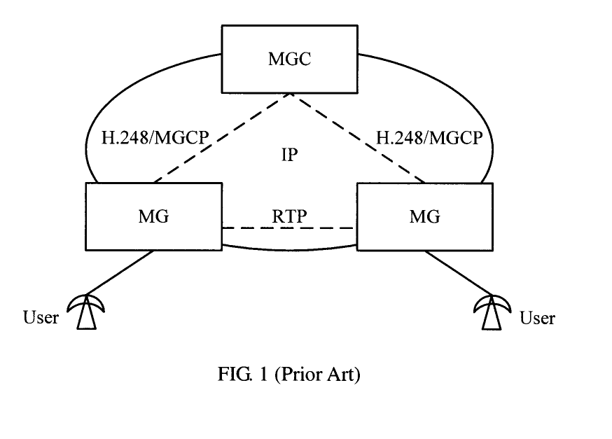

### DETAILED DESCRIPTION

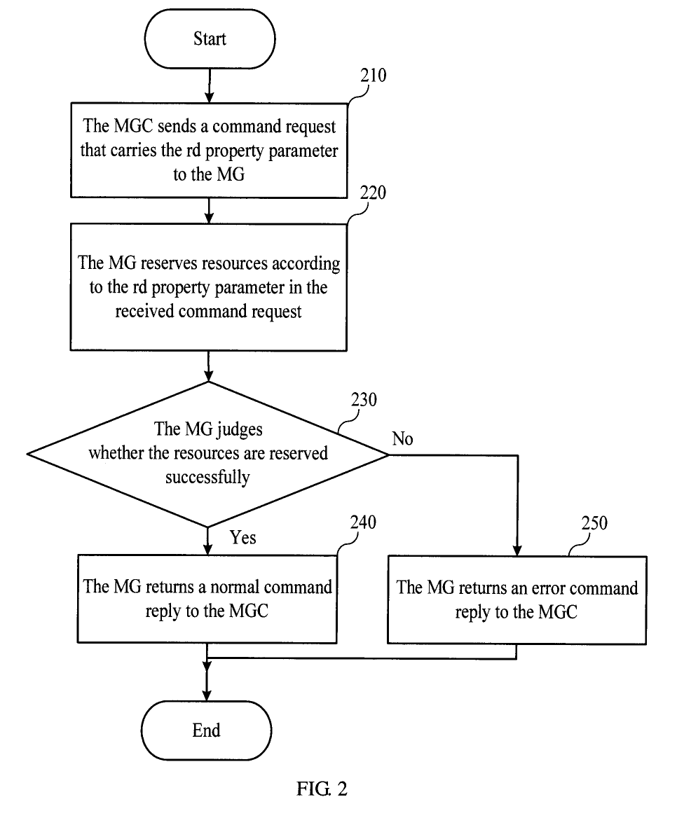

The first embodiment relates to a method for reserving resources. In this embodiment, a property parameter is extended to indicate the description and quantity of resources to be reserved in a specified context. The property parameter may be named “resource description (rd)”. The property parameter may be defined in an existing package or a new package. For example, the new package is named “Resource Reservation Configuration (RRC) package”. The property parameter is applied at the context level, and thus used as one of context attributes. This embodiment describes, for example, the method for reserving resources when the bearer control device is an MGC and the bearer device is an MG. The process is shown in FIG. 2.

Step 210: The MGC sends a command request that carries the rd property parameter to the MG where the rd property parameter carries the description and quantity of resources to be reserved in a specified context. The type of the property parameter may include a list of character strings, in which each character string indicates the description and quantity of a type of resources. That is, the instance or element of each character string in the list includes the description and quantity of resources. For example, a type of resource may be represented in a “quantity: resource” format. The resource description includes one or multiple specific resources. Each specific resource may include type and parameter information. For example, a specific resource may be represented in a “type: parameter” format. The type field may be IDs, such as Media, TerminationState, Stream, LocalControl, Local, Remote or Mode. The parameter field may be described by package item and/or SDP.

In the type field, the IDs may include each other. For example, Media includes TerminationState and Stream; Stream includes LocalControl, Local and Remote; Local includes Mode. In this embodiment, a superior resource type wildcards an inferior resource type. For example, if the ID in the type field is Stream, it indicates that the resource is reserved for both the local end and remote end. In addition, if some parts in the parameter field are ignored, “$” wildcard characters may be used to replace those parts. That is, the parameter of a specific resource supports wildcard characters.

The following examples describe how to indicate the description and quantity of resources to be reserved in a specified context by using the rd property parameter.

### Example 1

### Reserve resources for five terminations that can receive and send media streams outside a context and ten terminations that can only send media streams outside a context in a specified context. Two types of resources need to be reserved in the specified context. In the first type, there are five terminations that can receive and send media streams outside the context; in the second type, there are ten terminations can only send media streams outside the context. Thus, the property parameter may be represented as follows:

rrc/rd=“5:localcontrol:sendreceive”, “10:localcontrol: sendonly”

### Example 2

### Reserve resources for two terminations with audio/video and three terminations with audio only in the specified context. Two types of resources need to be reserved in the specified context. In the first type, there are two terminations that include an audio resource and a video resource. In the second type, there are three terminations that include only an audio resource. Thus, the property attribute may be represented as follows:

rrc/rd= “2:stream:SDP(v=0
c=IN IP4 $
m=audio $ $ $),
stream:SDP(v=0
c=IN IP4 $
m=video $ $ $)”,
“3:stream:SDP(v=0
c=IN IP4 $
m=audio $ $ $)”

Because the resource type is reflected as the termination type, the rd property parameter carried in the command request is reflected as reserving resources for a certain number of terminations in a specified context. However, this does not mean that these terminations are added to the context.

The description and quantity of resources to be reserved in the specified context is carried in a property parameter. Thus, when a same type of resources is reserved for multiple users, it is unnecessary to instruct to reserve the resources for each user in turn, which improves the efficiency in reserving the same type of resources. In addition, the efficiency in reserving the same type of resources can be improved simply by extending the existing protocol, so the implementation is feasible.

Step 220: The MG reserves resources in the specified context according to the rd property parameter in the received command request. For example, if the MG receives the following rd property parameter in the command request: 5:localcontrol:sendreceive, and 10:localcontrol:sendonly, the MG reserves resources for five terminations that can receive and send media streams outside the context and ten terminations that can only send media streams outside the context in the specified context.

Step 230: The MG judges whether the resources are reserved successfully; if so, the process proceeds to step 240; otherwise the process goes to step 250.

Step 240: If the resources are reserved successfully, the MG returns a normal command reply that indicates reservation success to the MGC.

Step 250: If the MG fails to reserve the resources, the MG returns an error command reply that indicates reservation failure to the MGC, wherein the error command reply includes an error code and/or an error description text. For example, if the error command reply includes “510 Insufficient Resource”, it indicates that the resource is insufficient. The MG returns a reply to the MGC, so that the MGC can know the resource reservation result and perform subsequent operations, which reduces the probability of errors.

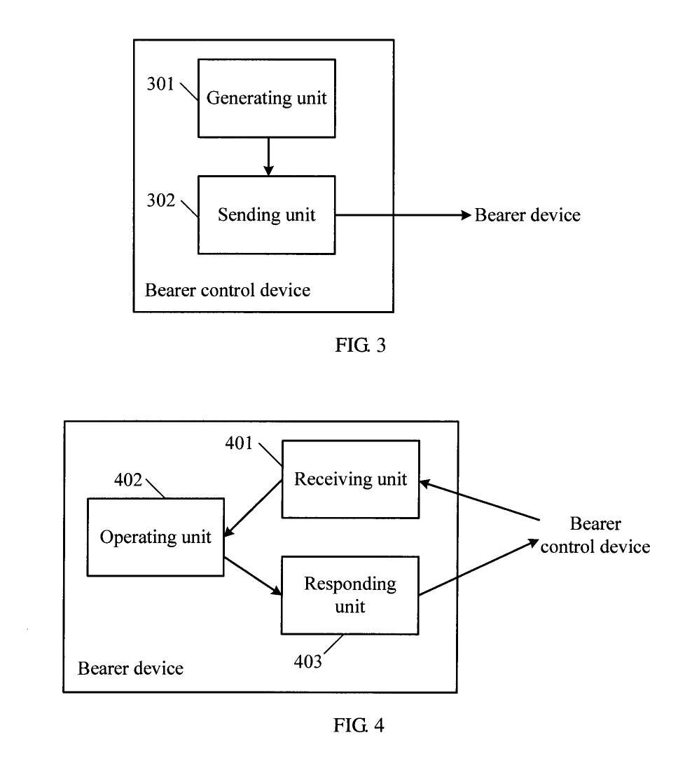

The second embodiment relates to a bearer control device. The bearer control device may be an MGC. As shown in FIG. 3, the bearer control device includes: a generating unit 301, configured to generate a message that instructs to reserve resources, wherein the message carries the description and quantity of the resources to be reserved in a specified context; and a sending unit 302, configured to send the message generated by the generating unit to a bearer device.

The message that instructs to reserve resources is a command request. The description and quantity of the resources to be reserved in the specified context are carried in a property parameter in the command request. The type of the property parameter may include a list of character strings, in which each character string indicates the description and quantity of resources. That is, the instance or element of each character string in the list includes description and quantity of resources. For example, a resource may be represented in a “quantity: resource” format. The resource description includes one or multiple specific resources. Each specific resource includes type and parameter information. For example, a specific resource is represented in a “type: parameter” format. The type of specific resources may be one of the following: Media, TerminationState, Stream, LocalControl, Local, Remote, and Mode. A superior type wildcards all the inferior types. The parameter of a specific resource may be described by package item and/or SDP, and supports wildcard characters. That is, if some parts in the parameter field are ignored, “$” wildcard characters may be used to replace these parts.

In this embodiment, the description and quantity of resources to be reserved in the specified context may be carried in a property parameter. Thus, when a same type of resources is reserved for multiple users, it is unnecessary to instruct to reserve the resources for each user in turn, thus improving the efficiency in reserving the same type of resources. In addition, the efficiency in reserving the same type of resources can be improved simply by extending the existing protocol, so the implementation is feasible.

The third embodiment relates to a bearer device. The bearer device may be an MG. As shown in FIG. 4, the bearer device may include: a receiving unit 401, configured to receive a message that instructs to reserve resources from a bearer control device, wherein the message carries the description and quantity of the resources to be reserved in a specified context; an operating unit 402, configured to reserve the resources in the specified context according to the description and quantity of the resources in the message received by the receiving unit; and a responding unit 403, configured to: return a normal command reply that indicates reservation success to the bearer control device when the operating unit reserves the resources successfully; return an error command reply that indicates reservation failure to the bearer control device when the operating unit fails to reserve the resources, wherein the error command reply includes an error code and/or an error description text. After the MG reserves the resource in the specified context, the MG needs to return a reply to the MGC, so that the MGC can know the resource reservation result and perform subsequent operations, which reduces the probability of errors.

The message that instructs to reserve resources is a command request. The description and quantity of the resources to be reserved in the specified context may be carried in a property parameter in the command request.

In this embodiment, the bearer control device sends a message that instructs to reserve resources to the bearer device, wherein the message carries the description and quantity of the resources to be reserved in the specified context. The bearer device reserves the resources in the specified context according to the description and quantity of the resources in the message. When a same type of resources is reserved for multiple users, it is unnecessary to instruct to reserve the resources for each user in turn, thus improving the efficiency in reserving the same type of resources.

An extended property parameter in the command request is used to carry the description and quantity of resources to be reserved in the specified context. In addition, the efficiency in reserving the same type of resources can be improved simply by extending the existing protocol, so the implementation is feasible.

After the bearer device reserves the resources in the specified context, the bearer device may return a reply to the bearer control device, so that the bearer control device can know the resource reservation result and perform subsequent operations, which reduces the probability of errors.

In this embodiment, the bearer control device sends a message that instructs to reserve resources to the bearer device, wherein the message carries the description and quantity of the resources to be reserved in the specified context; the bearer device reserves the resources in the specified context according to the description and quantity of the resources in the message. Thus, when multiple terminations (each corresponds to a user) may be added to a context that represents a conference, the bearer device can be instructed to reserve termination resources for each user by a message that instructs to reserve resources and carries the description (for example, a termination can only send media streams outside the context) and quantity of the resources to be reserved in a specified context. When a same type of resources is reserved for multiple users, it is unnecessary to instruct to reserve the resources for each user in turn, thus improving the efficiency in reserving the same type of resources.

Although the present disclosure has been described through some exemplary embodiments and accompanying drawings, the disclosure is not limited to such embodiments. It is apparent that those skilled in the art can make various modifications and variations to the embodiments without departing from the spirit and scope of the disclosure.

What is claimed is:

1. A method for reserving resources, comprising:
receiving a message that instructs to reserve resources in a specified context, wherein the message carries a description and quantity of the resources to be reserved; and
reserving the resources in the specified context according to the description and quantity of the resources to be reserved in the message.

2. The method of claim 1, wherein:
the message that instructs to reserve the resources in the specified context is a command request and the description and quantity of the resources to be reserved are carried in a property parameter in the command request; and
wherein the reserving the resources in the specified context according to the description and quantity of the resources in the message comprises:
reserving the resources in the specified context according to the description and quantity of the resources to be reserved carried in the property parameter in the command request.

3. The method of claim 2, wherein:
the type of the property parameter is a list of character strings, each of which indicates the description and quantity of a type of resource; and
wherein the reserving the resources in the specified context according to the description and quantity of the resources in the message comprises:
reserving a certain number of resources according to each character string in the list.

4. The method of claim 1, wherein:
the description of the resources comprises at least a specific resource and each specific resource comprises type and parameter information, the type of specific resources is one of the following: Media, TerminationState, Stream, LocalControl, Local, Remote, and Mode, wherein a superior type wildcards all inferior types; and
wherein reserving the resources in the specified context according to the description and quantity of the resources in the message comprises:
reserving the resources according to the type and parameter information in each specific resource in the description of the resources.

5. The method of claim 4, wherein the parameter of the specific resource is described by package item and/or Session Description Protocol (SDP) and supports wildcard characters.

6. The method of claim 1, further comprising:
if reserving the resources successfully, returning a normal command reply that indicates reservation success; and
if failing to reserve the resource, returning an error command reply that indicates reservation failure, wherein the error command reply comprises an error code and/or an error description text.

7. A bearer control device, comprising:
a generating unit, configured to generate a message that instructs a bearer device to reserve resources in a specified context, wherein the message carries a description and quantity of the resources to be reserved; and
a sending unit, configured to send the message generated by the generating unit to the bearer device.

8. The bearer control device of claim 7, wherein the bearer control device is a Media Gateway Controller (MGC).

9. A bearer device, comprising:
a receiving unit, configured to receive a message that instructs to reserve resources in a specified context from a bearer control device, wherein the message carries a description and quantity of the resources to be reserved; and
an operating unit, configured to reserve the resources in the specified context according to the description and quantity of the resources in the message.

10. The bearer device of claim 9, further comprising:
a responding unit, configured to:
send a normal command reply that indicates reservation success to the bearer control device when the operating unit reserves the resources successfully; and
send an error command reply that indicates reservation failure to the bearer control device when the operating unit fails to reserve the resources.

11. The bearer device of claim 9, wherein the bearer device is a Media Gateway (MG).

12. The bearer device of claim 10, wherein the bearer device is a Media Gateway (MG).
